(19) United States
(12) Patent Application Publication
(10) Pub. No.: US 2022/0275598 A1
(43) Pub. Date: Sep. 1, 2022

(54) SUPPORT DEVICE OF UNDERGROUND INSTALLED OBJECTS AND MANUFACTURING METHOD OF SUPPORT DEVICE

(71) Applicant: NIPPON TELEGRAPH AND TELEPHONE CORPORATION, Tokyo (JP)

(72) Inventors: Norihiro FUJIMOTO, Tokyo (JP); Yosuke OKAMURA, Tokyo (JP); Kazuhiko GOTO, Tokyo (JP)

(73) Assignee: NIPPON TELEGRAPH AND TELEPHONE CORPORATION, Tokyo (JP)

(21) Appl. No.: 17/627,617

(22) PCT Filed: Jul. 18, 2019
(86) PCT No.: PCT/JP2019/028309

§ 371 Date: Jan. 14, 2022

(51) Int. Cl. E02D 29/12; F16M 13/02

(52) U.S. Cl. CPC E02D 29/12; F16M 13/02

(57) ABSTRACT

Provided are an underground installation support device improving installation workability of a support member supporting an underground installation and a method of manufacturing the support device. A support device 100 according to the disclosure is a support device 100 supporting an underground installation (a communication cable 700) and including a vertical frame member 20 that extends in a substantially vertical direction, lateral frame members 30A and 30B that are attached to the vertical frame member 20 and extend in a substantially horizontal direction, and an installation support member 40 that is attached to the vertical frame member 20 and the support device is disposed on a bottom portion (a bottom wall 505) of an underground cavity (a manhole 500).

### TECHNICAL FIELD

This disclosure relates to an underground installation support device and a method of manufacturing the support device.

### BACKGROUND ART

Underground cavities such as manholes and hand holes are installed as places for connecting and inspecting underground installations such as power and communication cables buried in the ground. In the manhole, a hardware such as a flat steel or a brace disclosed in, for example, Non Patent Literature 1 is installed on a side wall of the manhole and power and communication cables or the like are supported by the hardware. As a result, workability in the manhole is secured.

Incidentally, because water flows into the underground cavities such as the manhole from the outside, the hardware may be corroded. Thus, it is necessary to periodically inspect the hardware, remove the hardware which may not support cables due to corrosion or the like, and install a new hardware.

### CITATION LIST

### Non Patent Literature

NPL 1: “Distribution Communication Catalog”, p. 93, [online], Otani Kogyo Co., Ltd., [Search on Jul. 8, 2019], Internet <URL: http://www.otanikogyo.com/dcms_media/other/catalog_haidentsusin.pdf>

### SUMMARY OF THE INVENTION

### Technical Problem

However, it is necessary to temporarily transfer power and communication cables or the like in order to remove the corroded hardware and install a new hardware. Thus, because an additional operation for temporary transfer needs to be performed, there is room for improvement from the viewpoint of work efficiency.

Thus, an object of the disclosure that has been made in view of such a point is to provide an underground installation support device improving installation workability of a support member supporting an underground installation and a method of manufacturing the support device.

### Means for Solving the Problem

In order to solve the above-described problems, an underground installation support device according to the disclosure is a support device supporting an underground installation including: a vertical frame member that extends in a substantially vertical direction; a lateral frame member that is attached to the vertical frame member and extends in a substantially horizontal direction; and an installation support member that is attached to at least one of the vertical frame member or the lateral frame member, wherein the support device is disposed on a bottom portion of an underground cavity.

Further, in order to solve the above-described problems, a method of manufacturing a support device according to the disclosure is a method of manufacturing a support device supporting an underground installation and disposed on a bottom portion of an underground cavity, including: fixing a vertical frame member extending in a substantially vertical direction and a lateral frame member extending in a substantially horizontal direction; disposing at least one of the vertical frame member or the lateral frame member on the bottom portion of the underground cavity directly or through another member; and attaching an installation support member to at least one of the vertical frame member or the lateral frame member.

### Effects of the Invention

According to the disclosure, it is possible to provide an underground installation support device improving installation workability of a support member supporting an underground installation and a method of manufacturing the support device.

### BRIEF DESCRIPTION OF DRAWINGS

FIG. 1A is a plan view of a support device according to a first embodiment of the disclosure.

FIG. 1B is a front view of the support device according to the first embodiment of the disclosure.

FIG. 1C is a side view of the support device according to the first embodiment of the disclosure.

FIG. 2A is a detailed view of a part A in FIG. 1A.

FIG. 2B is a detailed view of a part B in FIG. 1B.

FIG. 3 is a flowchart illustrating a procedure of a method of manufacturing a support device according to the first embodiment of the disclosure.

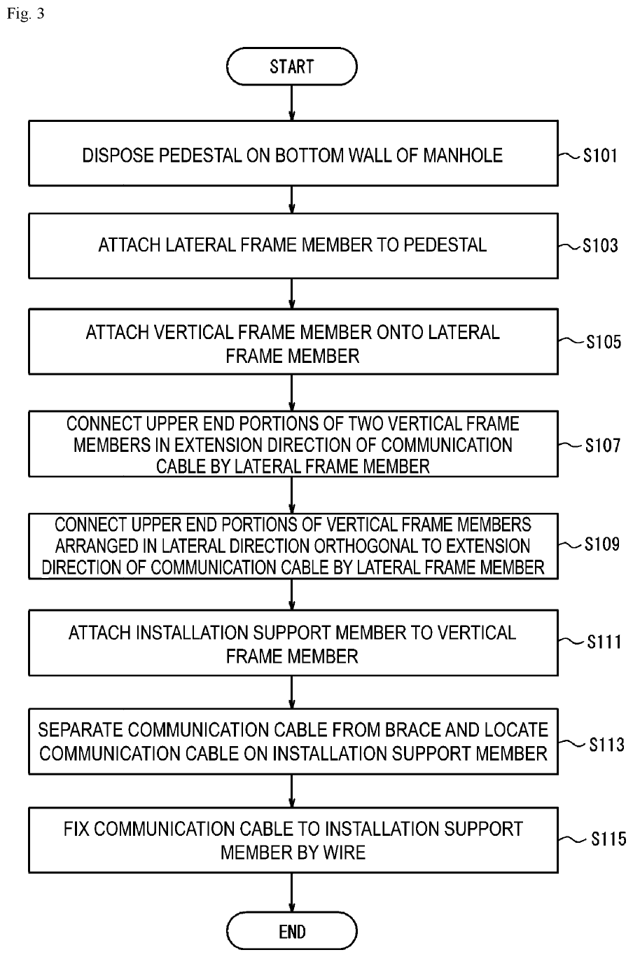

FIG. 4A is a plan view illustrating a state in which pedestals and lower lateral frame members of the support device according to the first embodiment of the disclosure have been installed.

FIG. 4B is a front view illustrating a state in which the pedestals and the lower lateral frame members of the support device according to the first embodiment of the disclosure have been installed.

FIG. 4C is a side view illustrating a state in which the pedestals and the lower lateral frame members of the support device according to the first embodiment of the disclosure have been installed.

FIG. 5A is a plan view illustrating a state in which vertical frame members and upper longitudinal lateral frame members have been installed after the state of FIG. 4A.

FIG. 5B is a front view illustrating a state in which the vertical frame members and the upper longitudinal lateral frame members have been installed after the state of FIG. 4B.

FIG. 5C is a side view illustrating a state in which the vertical frame members and the upper longitudinal lateral frame members have been installed after the state of FIG. 4C.

FIG. 6A is a plan view illustrating a state in which upper transverse lateral frame members have been installed after the state of FIG. 5A.

FIG. 6B is a front view illustrating a state of the upper transverse lateral frame member have been installed after the state of FIG. 5B.

FIG. 6C is a side view illustrating a state of the upper transverse lateral frame member have been installed after the state of FIG. 5C.

FIG. 7A is a plan view illustrating a first modified example of the support device according to the first embodiment of the disclosure.

FIG. 7B is a front view illustrating the first modified example of the support device according to the first embodiment of the disclosure.

FIG. 7C is a detailed view of a part C in FIG. 7B.

FIG. 8A is a plan view illustrating a second modified example of the support device according to the first embodiment of the disclosure.

FIG. 8B is a front view illustrating the second modified example of the support device according to the first embodiment of the disclosure.

FIG. 9 is a side view illustrating a third modified example of the support device according to the first embodiment of the disclosure.

FIG. 10A is a plan view of a support device according to a second embodiment of the disclosure.

FIG. 10B is a front view of the support device according to the second embodiment of the disclosure.

FIG. 10C is a side view of the support device according to the second embodiment of the disclosure.

FIG. 11 is a flowchart illustrating a procedure of performing a method of manufacturing a support device according to the second embodiment of the disclosure.

FIG. 12A is a plan view illustrating a state in which column members of the support device according to the second embodiment of the disclosure have been installed.

FIG. 12B is a front view illustrating a state in which the column members of the support device according to the second embodiment of the disclosure have been installed.

FIG. 12C is a side view illustrating a state in which the column members of the support device according to the second embodiment of the disclosure have been installed.

FIG. 13A is a plan view illustrating a state in which lower lateral frame members have been installed after the state of FIG. 12A.

FIG. 13B is a front view illustrating a state in which the lower lateral frame members have been installed after the state of FIG. 12B.

FIG. 13C is a side view illustrating a state in which the lower lateral frame members have been installed after the state of FIG. 12C.

FIG. 14A is a plan view illustrating a state in which vertical frame members and upper longitudinal lateral frame members have been installed after the state of FIG. 13A.

FIG. 14B is a front view illustrating a state in which the vertical frame members and the upper longitudinal lateral frame members have been installed after the state of FIG. 13B.

FIG. 14C is a side view illustrating a state in which upper transverse lateral frame members have been installed after the state of FIG. 13C.

FIG. 15A is a plan view illustrating a state of the upper transverse lateral frame members have been installed after the state of FIG. 14A.

FIG. 15B is a front view illustrating a state in which the upper transverse lateral frame members have been installed after the state of FIG. 14B.

FIG. 15C is a side view illustrating an installation state of the upper transverse lateral frame members have been installed after the state of FIG. 14C.

FIG. 16A is a plan view illustrating a modified example of the support device according to the second embodiment of the disclosure.

FIG. 16B is a front view illustrating a modified example of the support device according to the second embodiment of the disclosure.

FIG. 16C is a side view illustrating a modified example of the support device according to the second embodiment of the disclosure.

FIG. 17A is a plan view of a support device according to a third embodiment of the disclosure.

FIG. 17B is a front view of the support device according to the third embodiment of the disclosure.

FIG. 18 is a detailed view of a part D in FIG. 17B (before and after assembly).

### DESCRIPTION OF EMBODIMENTS

Hereinafter, a support device 100 according to a first embodiment of the disclosure will be described with reference to the drawings.

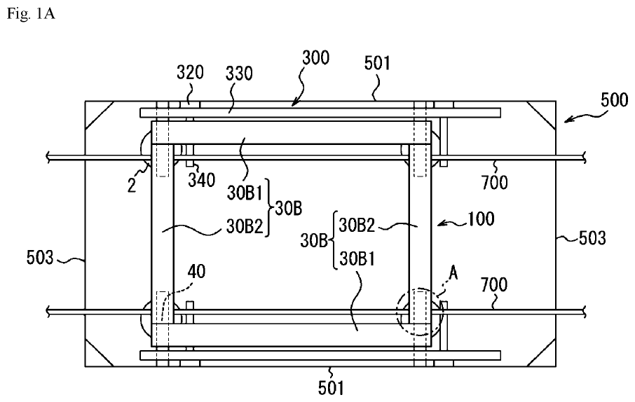

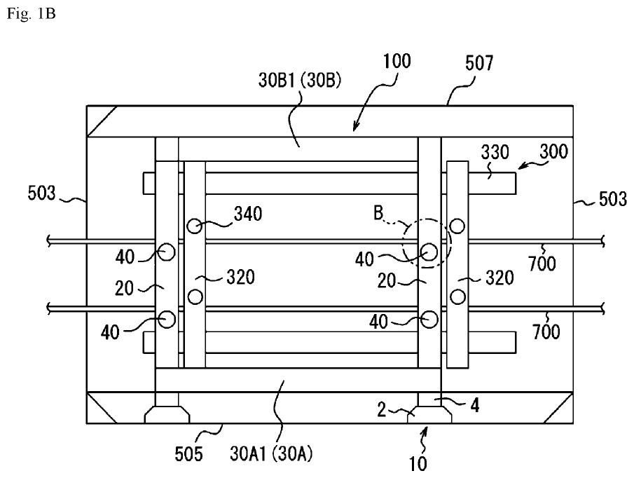

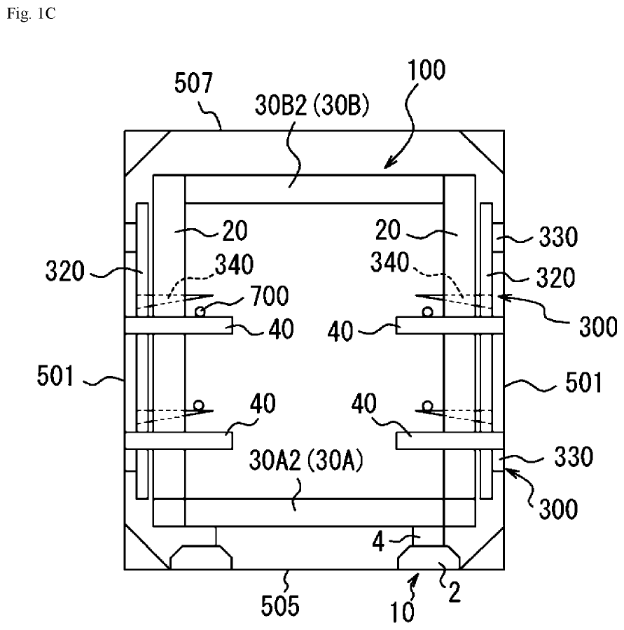

The support device 100 according to this embodiment is a device that is disposed on a bottom portion of a manhole 500 corresponding to an underground cavity and that is configured to support an underground installation such as power and communication cables. In this embodiment, a description will be made on the assumption that the support device 100 supports communication cables 700 each including an optical cable. The support device 100 includes, as illustrated in FIGS. 1A to 1C, pedestals 10 which support a lower portion of the support device 100, a lateral frame member 30A which connects the pedestals 10 in a substantially horizontal direction, vertical frame members 20 each of which is attached to the lateral frame member 30A and extends in a substantially vertical direction, a lateral frame member 30B which is attached to the upper end portion of each vertical frame member 20, connects the vertical frame members 20, and extends in a substantially horizontal direction, and installation support members 40 each of which is attached to any of the vertical frame members 20 and extends in a substantially horizontal direction orthogonal to the extension direction of the communication cables 700.

First, the manhole 500 where the support device 100 of this embodiment is disposed will be described. The manhole is an underground cavity including a cylindrical neck provided directly below a manhole cover facing a road or the like and a substantially rectangular main body connected to a lower portion of the neck and the manhole 500 illustrated in FIGS. 1A to 1C indicates the main body among them. The manhole 500 includes longitudinal walls 501 which extend along the extension direction of the communication cables 700, transverse walls 503 which are orthogonal to the longitudinal walls 501 and each of which buries a duct through which the corresponding communication cable 700 passes, a bottom wall 505 which is provided with the pedestals 10 of the support device 100 and constitutes a bottom portion of the manhole 500, and a top wall 507 which blocks upper end portions of the longitudinal walls 501 and the transverse walls 503. In this embodiment, the length in the extension direction of the communication cables 700 (the left and right direction of FIG. 1A) in each longitudinal wall 501 is longer than the length in the direction (the up and down direction of FIG. 1A) orthogonal to the longitudinal wall 501 in each transverse wall 503. That is, in this embodiment, the extension direction of the communication cables 700 matches the longitudinal direction (the left and right direction of FIG. 1A) in the plan view of the manhole 500.

Each pedestal 10 includes a base frame 4 and a base 2 which is attached to a lower end portion of the base frame 4, has a cross-sectional area larger than that of the base frame 4, and is grounded to the bottom portion of the manhole 500. In this embodiment, a carbon steel material for a mechanical structure defined by, for example, JIS 4051: 2016 can be used as the materials of the base frame 4 and the base 2. The steel material used in the pedestal 10 is, for example, S45C or the like. Further, other steel materials having predetermined strength, non-ferrous metals such as aluminum, or non-metallic materials such as fiber reinforced plastics (FRP) may be used. Further, a synthetic resin material, a rubber material, and the like may be used in the base 2.

In this embodiment, various fixing methods such as engagement including screw fastening, fitting, welding, and bonding can be used to fix the members to each other.

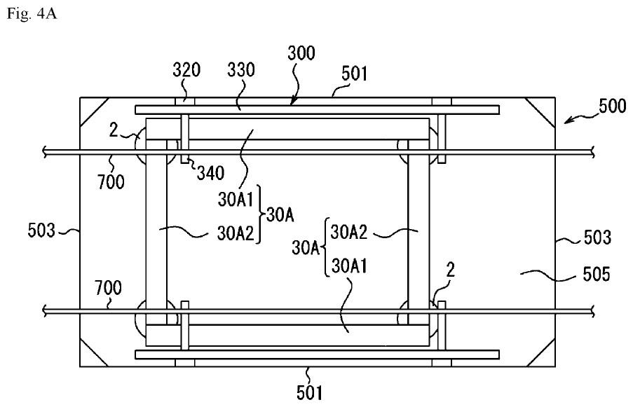

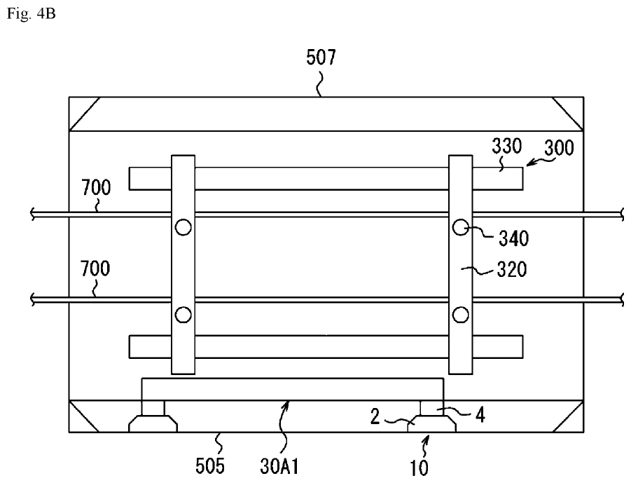

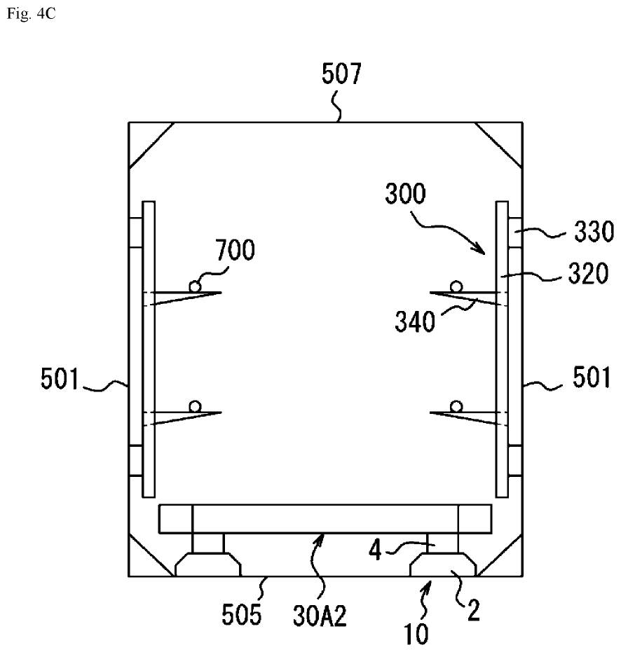

As illustrated in FIGS. 1A to 1C, the lateral frame member 30A connects the pedestals 10 disposed at four positions on the bottom wall 505 of the manhole 500 in the horizontal direction and includes a longitudinal lateral frame member 30A1 that extends along the extension direction of the communication cables 700 (the left and right direction of FIG. 1B) and a transverse lateral frame member 30A2 that extends in the direction orthogonal to the extension direction of the communication cables 700 (see FIG. 4A). Further, the upper end portions of the vertical frame members 20 to be described later are provided with the lateral frame member 30B that connects the vertical frame members 20 to each other. The lateral frame member 30B is also provided with, as illustrated in FIG. 1A, a longitudinal lateral frame member 30B1 that extends along the extension direction of the communication cables 700 and a transverse lateral frame member 30B2 that extends in the direction orthogonal to the extension direction of the communication cables 700.

Similarly to the pedestal 10, a carbon steel material for a mechanical structure defined by, for example, JIS 4051: 2016 can be used as the materials of the lateral frame members 30A and 30B. Further, other steel materials having predetermined strength, non-ferrous metals such as aluminum, or non-metallic materials such as fiber reinforced plastics (FRP) may be used. Additionally, it is preferable to use a material such as FRP not easily corroded by water or the like or to apply a surface treatment preventing easy corrosion.

As illustrated in FIGS. 1B, 1C, and the like, the vertical frame members 20 are attached to four corners of the upper surface of the lateral frame member 30A and extend in a substantially vertical direction (the up and down direction of FIGS. 1B and 1C). As illustrated in FIGS. 1B and 1C, installation support members 40 that each support the communication cable 700 are attached to two height positions between the upper end portion and the lower end portion of each vertical frame member 20. In this embodiment, each installation support member 40 is orthogonal to the extension direction of the communication cables 700 and extends in a substantially horizontal direction. However, the disclosure is not limited to this aspect and the installation support member 40 may be inclined with respect to the horizontal direction orthogonal to the extension direction of the communication cables 700.

The lateral frame member 30B that connects the vertical frame members 20 to each other and extends in a substantially horizontal direction is attached to the upper end portion of each vertical frame member 20.

Additionally, similarly to the lateral frame members 30A and 30B, carbon steel materials for mechanical structures, other steel materials, non-ferrous metals, or non-metallic materials can be used for the vertical frame member 20. Further, the material of the vertical frame member 20 may be different from the materials of the lateral frame members 30A and 30B.

In this embodiment, square bars are used for the lateral frame members 30A and 30B and the vertical frame member 20, but the disclosure is not limited thereto. A round material may be used instead of the square material or a pipe material may be used instead of the bar material.

In this embodiment, as illustrated in FIGS. 1B, 1C, and the like, the installation support member 40 is a substantially columnar elongated member and can be fixed by being fitted to a fitting hole provided in the vertical frame member 20. The installation support member 40 may be fixed to the vertical frame member 20 by other means such as engagement, welding, and bonding, for example. Further, the installation support member 40 may be fixed to the lateral frame members 30A and 30B.

In this embodiment, the installation support member 40 is formed to be disposed in the vicinity of an existing brace 340 to be described later. According to such a configuration, when it is necessary to replace the existing brace 340 due to corrosion or the like, it is not necessary to temporarily transfer the communication cable 700 and it is possible to transfer the communication cable from the existing brace 340 to the corresponding installation support member 40 of this embodiment. Thus, it is not necessary to perform an additional operation for temporary transfer and it is possible to improve the work efficiency.

The “vicinity of the existing brace 340” mentioned herein means that the installation support member is disposed at a position close to the brace 340 to a degree that no stress affecting the communication cable 700 occurs even when each portion of the communication cable 700 attached to each brace 340 is relocated and fixed onto the adjacent installation support member 40.

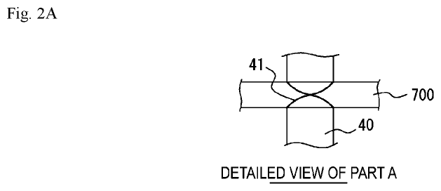

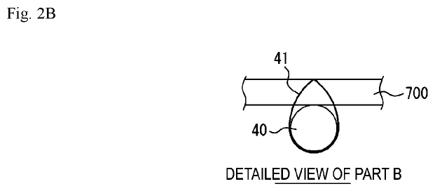

For the attachment of the communication cable 700 to the installation support member 40, first, as illustrated in FIGS. 2A and 2B, the communication cable 700 is disposed on the installation support member 40 in a contact state in a substantially orthogonal direction. Next, a wire 41 is wound about half in the circumferential direction along the outer circumferential surface of the installation support member 40 (see FIG. 2B) and is further wound while being oriented obliquely in the circumferential direction and the axial direction along the outer circumferential surface of the communication cable 700, so that the communication cable 700 can be fixed to the installation support member 40.

Further, the shape of the installation support member 40 is preferably columnar from the viewpoint of ease of fixing by the wire 41, but may have other shapes such as elliptical pillar shapes, prism shapes, and the like.

As the material of the installation support member 40, high weather resistant materials such as fiber reinforced plastics (FRP) or non-ferrous metals such as aluminum may be used in addition to the steel material. Further, a surface treatment preventing easy corrosion against water or the like may be used.

FIGS. 1A to 1C illustrate an existing hardware assembly 300 supporting the communication cables 700 in addition to the support device 100 according to this embodiment. The hardware assembly 300 includes lateral flat steels 330 each of which is installed in the corresponding longitudinal wall 501 of the manhole 500 and extends in the extension direction of the communication cables 700, vertical flat steels 320 each of which is attached to the corresponding lateral flat steel 330 and extends in the vertical direction, and the braces 340 which are provided at two height positions between the upper end portion and the lower end portion of each vertical flat steel 320 and support the communication cables 700. Each brace 340 is orthogonal to the extension direction of the communication cables 700, extends in a substantially horizontal direction, and has a tapered shape in which the thickness in the vertical direction gradually decreases from the attachment portion to the vertical flat steel 320 toward the front end.

In this embodiment, the vertical frame member 20 is disposed on the outside in relation to the inner end of the horizontal direction (the left and right direction of FIG. 1C) orthogonal to the extension direction of the communication cables 700 in the existing brace 340. With such a configuration, the area inside the brace 340 can be secured as a work space.

Next, a procedure of manufacturing the support device 100 according to this embodiment will be described. When manufacturing the support device 100, first, four pedestals 10 each including the base frame 4 and the base 2 are disposed on the bottom wall 505 of the manhole 500 (step S101) and the lateral frame member 30A is attached onto the pedestals 10 (step S103). In this embodiment, as illustrated in FIG. 4A, the pedestals 10 are disposed at four corner positions of the substantially rectangular shape on the bottom wall 505. In the example of FIG. 4A, the pedestals 10 are disposed such that the gap in the direction along the extension direction of the communication cables 700 (the left and right direction of FIG. 4A) becomes larger than the gap in the direction (the up and down direction of FIG. 4A) orthogonal to the extension direction of the communication cables 700. With such a configuration, it is possible to more stably support the communication cable 700 in the extension direction by taking advantage of the shape of the internal space of the manhole 500.

As illustrated in FIG. 4A, the longitudinal lateral frame member 30A1 of the lateral frame member 30A fixed onto the pedestals 10 is disposed on the inside in the direction (the up and down direction of FIG. 4A) orthogonal to the extension direction of the communication cables 700 in relation to the vertical flat steel 320 and the lateral flat steel 330 and is disposed on the outside in relation to the inner end of the brace 340 in the plan view.

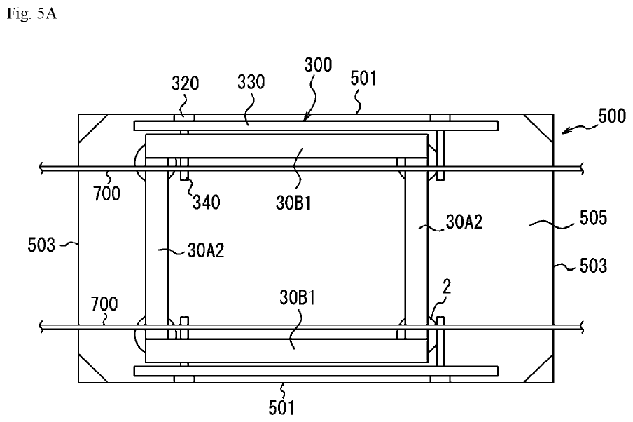

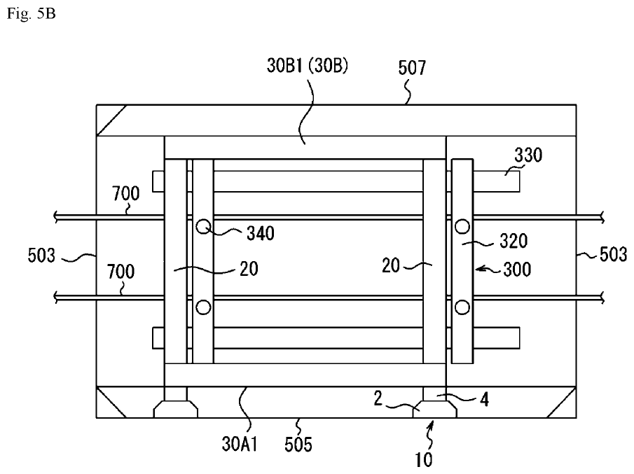

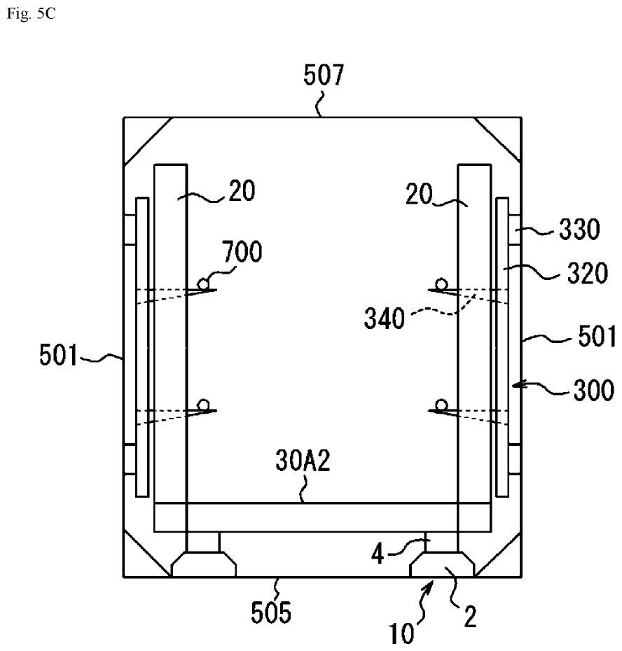

After the lateral frame member 30A is attached to the pedestal 10 by step S103, four vertical frame members 20 are attached to four corners of the lateral frame member 30A in the plan view as illustrated in FIGS. 5A to 5C (step S105). Further, as illustrated in FIG. 5B, the lateral frame member 30B (the longitudinal lateral frame member 30B1) connects the upper end portions of two vertical frame members 20 in the extension direction of the communication cables 700 (the left and right direction of FIG. 5A) among four vertical frame members 20 (step S107).

In step S105, as illustrated in FIG. 5C, the vertical frame member 20 is disposed on the inside in the direction (the left and right direction of FIG. 5C) orthogonal to the extension direction of the communication cables 700 in relation to the vertical flat steel 320 and the lateral flat steel 330. Further, the vertical frame member 20 is disposed on the outside in relation to the inner end of the brace 340. As a result, it is possible to secure the same work space as the work space secured inside the brace 340 in the existing hardware assembly 300 even after the support device 100 according to this embodiment is installed. Further, because the vertical frame member 20 and the longitudinal lateral frame members 30A1 and 30B1 are disposed in the vicinity of the longitudinal wall 501, the vertical frame member 20 and the longitudinal lateral frame members 30A1 and 30B1 are supported by the longitudinal wall 501 even when the manhole 500 is vibrated in the horizontal direction (the up and down direction of FIG. 5A) orthogonal to the extension direction of the communication cables 700 due to earthquake or the like. Thus, it is possible to suppress a load applied to the support device 100 due to vibration.

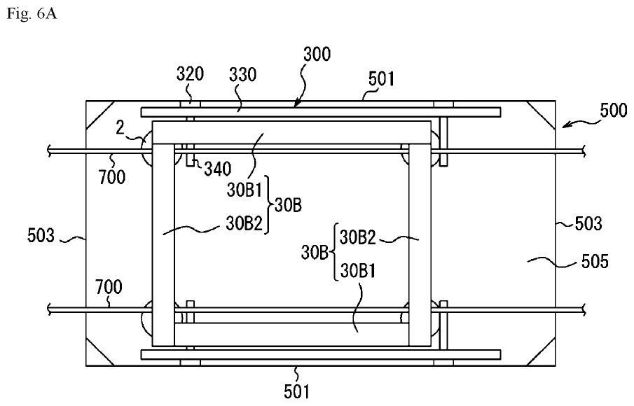

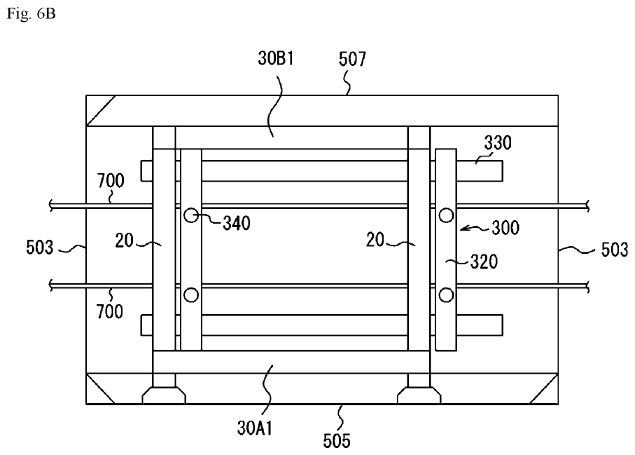

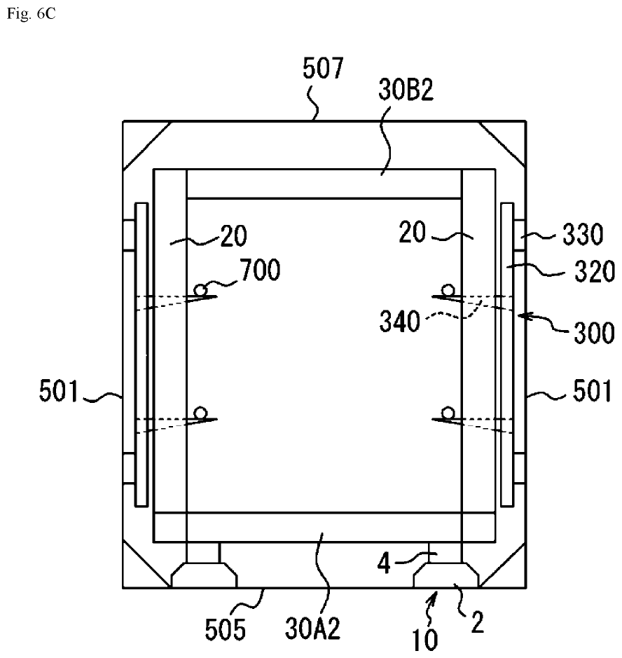

Next, the lateral frame member 30B (the transverse lateral frame member 30B2) connects the upper end portions of the vertical frame members 20 arranged in the horizontal direction (the left and right direction of FIG. 6C) orthogonal to the extension direction of the communication cables 700 (the left and right direction of FIG. 6A) (step S109). As a result, the skeleton of the support device 100 is completed.

Next, the installation support members 40 are attached to the vertical frame member 20 (step S111). For example, each installation support member 40 is attached by fixing the installation support member using a bolt or the like from the side opposite to a through-hole provided in the vertical frame member 20 (the outside of the left and right direction of FIG. 6C). Alternatively, gourd-shaped attachment holes may be used as another configuration. Further, the number of the installed communication cables 700 may be increased in such a manner that the installation support member 40 penetrates a hole provided in the vertical frame member 20 and the installation support member 40 protrudes toward the outside of the vertical frame member 20 (the outside of the left and right direction of FIG. 6C).

Further, it is preferable that the attachment place of the installation support member 40 be in the vicinity of the brace 340 in the hardware assembly 300. As a result, it is not necessary to temporarily transfer the communication cable 700 when the communication cable 700 is relocated from the brace 340 to the installation support member 40 according to this embodiment. Further, it is possible to reduce the possibility that the communication cable 700 may be stressed when relocating the communication cable 700. Further, the installation support member 40 may be attached to the lateral frame members 30A and 30B instead of the vertical frame member 20.

After the installation support members 40 are attached in step S111, the communication cable 700 is separated from the brace 340 and is located on the corresponding installation support member 40 (step S113). Then, as illustrated in FIGS. 2A and 2B, the wire 41 is wound along the outer circumferential surfaces of the installation support member 40 and the communication cable 700 so that the communication cable 700 is fixed to the installation support member 40 (step S115). As a result, as illustrated in FIGS. 1A to 1C, the communication cable 700 can be supported by the newly installed support device 100.

Further, as understood from FIG. 1A, in this embodiment, the vertical frame member 20 and the lateral frame members 30A and 30B are each disposed at a position farther from the longitudinal wall 501 than the vertical flat steel 320 and the lateral flat steel 330. Thus, it is possible to relatively easily remove the hardware assembly 300 from the manhole 500 by separating the vertical flat steels 320 and the lateral flat steels 330 from the longitudinal walls 501 after the braces 340 are separated from the hardware assembly 300.

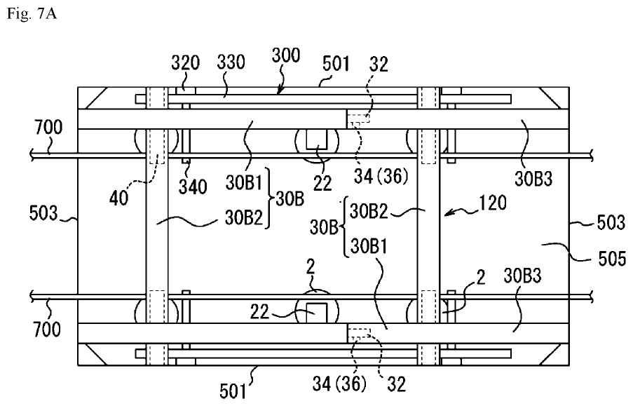

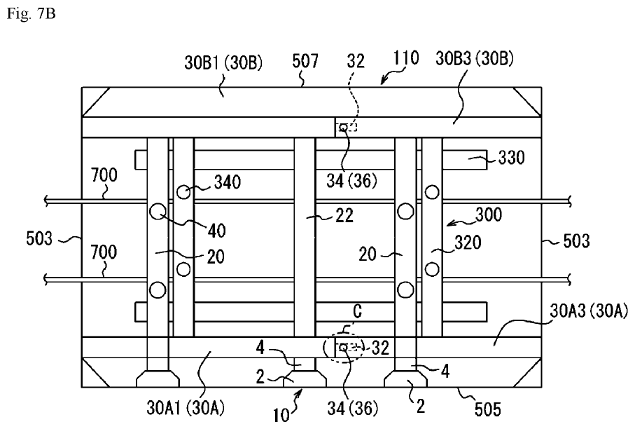

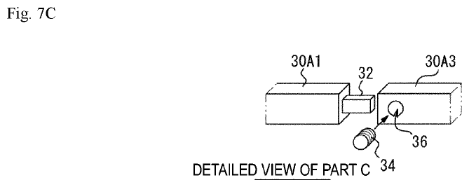

FIGS. 7A to 7C illustrate a support device 110 which is a first modified example of this embodiment. In the support device 110, the lateral frame members 30A and 30B are formed to extend to a position close to the longitudinal wall 501 and the transverse wall 503 compared to the support device 100 illustrated in FIGS. 5A to 5C. With such a configuration, because the support device 110 is also supported by the longitudinal wall 501 and the transverse wall 503 even when the manhole 500 is vibrated, it is possible to protect the support device 110 from the vibration of the manhole 500.

In this modified example, the longitudinal lateral frame members 30A1 and 30B1 are respectively connected to the longitudinal lateral frame members 30A3 and 30B3 at one end portions in the longitudinal direction so that the longitudinal lateral frame members 30A1 and 30B1 extend to a position close to the transverse wall 503. As illustrated in FIG. 7C, this connection is realized in such a manner that a convex portion 32 provided at one end portion of the longitudinal lateral frame member 30A1 is slidably fitted to a concave portion (not illustrated) provided at an end portion facing the convex portion 32 in the longitudinal lateral frame member 30A3. With this configuration, the longitudinal lateral frame members 30A1 and 30B1 and the longitudinal lateral frame members 30A3 and 30B3 can be disposed in the vicinity of the transverse wall 503. Additionally, FIG. 7C only illustrates the longitudinal lateral frame member 30A1 and the longitudinal lateral frame member 30A3, but the same applies to the fitting of the longitudinal lateral frame member 30B1 and the longitudinal lateral frame member 30B3.

Further, in the example of FIG. 7C, the convex portion 32 having a width and a height smaller than those of the longitudinal lateral frame members 30A1 and 30B1 is provided and the convex portion 32 is fitted to the concave portion on the side of the longitudinal lateral frame members 30A3 and 30B3. However, the disclosure is not limited thereto. For example, the longitudinal lateral frame members 30A3 and 30B3 may be formed as members having a width and a height smaller than those of the longitudinal lateral frame members 30A1 and 30B1 and one end portion of the longitudinal lateral frame members 30A3 and 30B3 is fitted to a concave portion provided in the longitudinal lateral frame members 30A1 and 30B1.

In this embodiment, a support column 22 which stands from the base 2 in the vertical direction and supports the longitudinal lateral frame members 30A1 and 30B1 in the up and down direction is disposed in the vicinity of the connection position between the longitudinal lateral frame members 30A1 and 30B1 and the longitudinal lateral frame members 30A3 and 30B3. With this configuration, the strength (bending strength) in the up and down direction of the longitudinal lateral frame members 30A1 and 30B1 and the longitudinal lateral frame members 30A3 and 30B3 in the vicinity of the connection position can be supplemented by the support column 22.

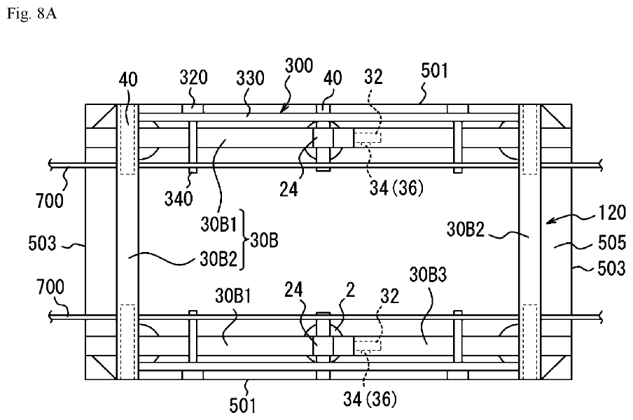

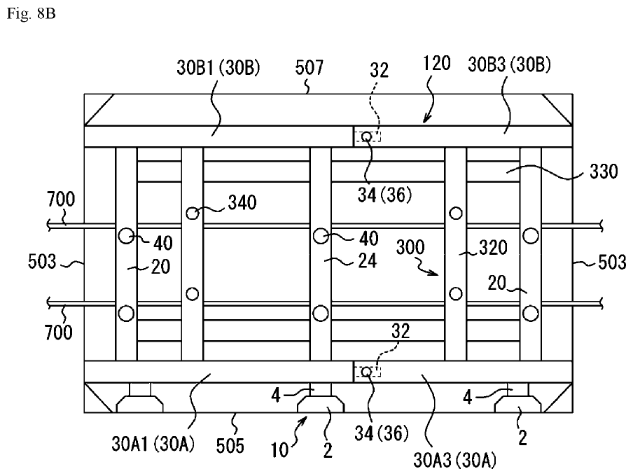

FIGS. 8A and 8B illustrate a support device 120 which is a second modified example of this embodiment. In the support device 120, the vertical frame member 20 and the transverse lateral frame members 30A2 and 30B2 are disposed to be closer to the transverse wall 503 compared to the support device 110 illustrated in FIGS. 7A to 7C. Thus, the gap between the vertical frame members 20 and the gap between the transverse lateral frame members 30A2 and 30B2 in the direction along the extension direction of the communication cables 700 are longer than those of the support device 110. In the second modified example illustrated in FIGS. 8A and 8B, a support column 24 which stands from the longitudinal lateral frame member 30A1 in the vertical direction and supports the longitudinal lateral frame member 30B1 in the up and down direction is disposed in the vicinity of the connection position between the longitudinal lateral frame members 30A1 and 30B1 and the longitudinal lateral frame members 30A3 and 30B3. Further, in the support device 120, the installation support members 40 are also attached to the support column 24. As a result, it is possible to support the communication cable 700 also by the installation support members 40 attached to the support column 24 in addition to the installation support members 40 attached to the vertical frame member 20. Thus, it is possible to more stably support the communication cable 700 even when the gap between the vertical frame members 20 and the gap between the transverse lateral frame members 30A2 and 30B2 in the direction along the extension direction of the communication cables 700 are long.

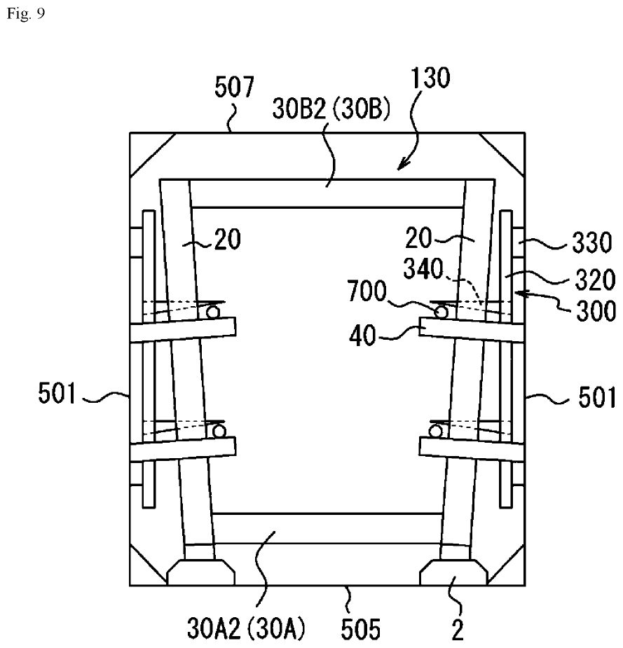

FIG. 9 illustrates a support device 130 which is a third modified example of this embodiment. In the support device 130, the vertical frame member 20 directly stands from the base 2. In the example of FIG. 9, the vertical frame member 20 is slightly inclined inward in the horizontal direction (the left and right direction of FIG. 9) orthogonal to the extension direction of the communication cable 700 while facing downward. Further, the installation support members 40 attached to the vertical frame member 20 in an orthogonal posture are also inclined in accordance with the inclination of the vertical frame member 20. With such a configuration, the load of the communication cable 700 or the like applied to the corresponding installation support member 40 is distributed in the direction (the downward direction along the vertical frame member 20) orthogonal to the installation support member 40 and the direction (the compression direction of the installation support member 40) along the installation support member 40. Thus, it is possible to reduce the bending load in the direction orthogonal to the installation support member 40.

As described above, the support device 100 according to this embodiment is the support device 100 supporting the underground installation (the communication cable 700) including the vertical frame members 20 that extends in a substantially vertical direction, the lateral frame members 30A and 30B that are attached to the vertical frame members 20 and extend in a substantially horizontal direction, and the installation support members 40 that are attached to the vertical frame members 20 and the support device is disposed on the bottom portion (the bottom wall 505) of the underground cavity (the manhole 500). By adopting such a configuration, because it is possible to transfer the underground installation (the communication cable 700 or the like) by installing the support device 100 while the existing hardware assembly 300 is kept installed, it is not necessary to perform an additional operation for the temporary transfer and it is possible to improve the work efficiency.

In the past, because the brace was installed on the wall of the manhole 500 through a flat steel or the like, the brace was vibrated together with the wall when the manhole 500 was vibrated due to earthquake or the like. As a result, a strong tension was applied to the communication cable 700 or the like in some cases. In this embodiment, because each installation support member 40 is attached to the vertical frame member 20 or the like standing upward from the bottom wall 505 of the manhole 500 through the pedestal 10, the installation support member is not vibrated together with the wall even when the manhole 500 is vibrated due to earthquake or the like. Thus, it is possible to alleviate a tension applied to the communication cable 700 or the like when vibration occurs. Further, in this embodiment, because the support device 100 is installed along the longitudinal wall 501 of the manhole 500, it is possible to support the inclination of the member by the longitudinal wall 501 even when the number of the communication cables 700 or the like installed in the installation support member 40 increases and an uneven load is applied to the lateral frame members 30A and 30B or the vertical frame member 20. Thus, it is possible to suppress the support device 100 from being inclined largely.

Further, in this embodiment, the lateral frame members 30A and 30B include the longitudinal lateral frame members 30A1 and 30B1 that extend in the extension direction of the underground installation (the communication cable 700) and the transverse lateral frame members 30A2 and 30B2 that extend in the horizontal direction orthogonal to the extension direction of the underground installation. Because the longitudinal lateral frame members 30A1, 30B1, 30A3, and 30B3 are formed such that a plurality of members are connected in the extension direction of the underground installation and one member (the longitudinal lateral frame members 30A1 and 30B1) of the plurality of members is slidably fitted to the other member (the longitudinal lateral frame members 30A3 and 30B3), the length in the extension direction of the underground installation is adjustable. By adopting such a configuration, it is possible to install the support device 100 at an appropriate size in accordance with the size of the space inside the manhole 500. Further, because the length can be adjusted such that the end portions of the longitudinal lateral frame members 30A1 and 30B1 and the longitudinal lateral frame members 30A3 and 30B3 are close to the transverse wall 503, the support device 110 is also supported by the transverse wall 503 even when the manhole 500 is vibrated. Thus, it is possible to protect the support device 110 from the vibration of the manhole 500.

Further, in this embodiment, the support column 22 which supports one member (the longitudinal lateral frame members 30A1 and 30B1) in the up and down direction is provided in the vicinity of the connection position between one member (the longitudinal lateral frame members 30A1 and 30B1) and the other member (the longitudinal lateral frame members 30A3 and 30B3). By adopting such a configuration, because the support column 22 supports the member in the vicinity of the connection position, it is possible to supplement the strength (bending strength) of the longitudinal lateral frame members 30A1 and 30B1 and the longitudinal lateral frame members 30A3 and 30B3 in the up and down direction by the support column 22. Thus, it is possible to increase the strength and seismic resistance of the support device 110.

Further, in this embodiment, the vertical frame member 20 is installed to be inclined inward in the horizontal direction orthogonal to the extension direction of the underground installation (the communication cable 700) while facing downward. By adopting such a configuration, the load of the underground installation applied to the installation support member 40 is distributed in the direction (the downward direction along the vertical frame member 20) orthogonal to the installation support member 40 and the direction (the compression direction of the installation support member 40) along the installation support member 40. Thus, it is possible to reduce the bending load in the direction orthogonal to the installation support member 40.

Further, in this embodiment, the vertical frame member 20 is disposed on the outside in relation to the inner end in the horizontal direction orthogonal to the extension direction of the underground installation in the existing support member (the brace 340) of the underground installation (the communication cable 700). By adopting such a configuration, it is possible to secure the same work space as the work space secured inside the brace 340 in the existing hardware assembly 300 even after the support device 100 according to this embodiment is installed.

Further, a method of manufacturing the support device according to this embodiment is a method of manufacturing the support device 100 supporting the underground installation (the communication cable 700) and the support device 100 is disposed on the bottom portion (the bottom wall 505) of the underground cavity (the manhole 500). This method includes fixing the vertical frame members 20 extending in the vertical direction and the lateral frame members 30A and 30B extending in the substantially horizontal direction, disposing the lateral frame members 30A and 30B on the bottom portion of the underground cavity through another member (the pedestal 10), and attaching the installation support members 40 to the vertical frame members 20. By adopting such a configuration, because it is possible to transfer the underground installation (the communication cable(s) 700 or the like) by installing the support device 100 while the existing hardware assembly 300 is kept installed, it is not necessary to perform an additional operation for the temporary transfer and it is possible to improve the work efficiency.

Next, a support device 200 according to the second embodiment of the disclosure will be described with reference to the drawings. Additionally, in the support device 200, the same reference signs will be assigned to parts having the same structure or function as that of the first embodiment.

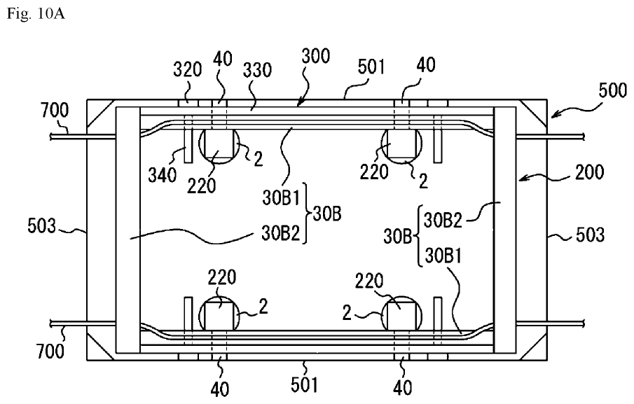

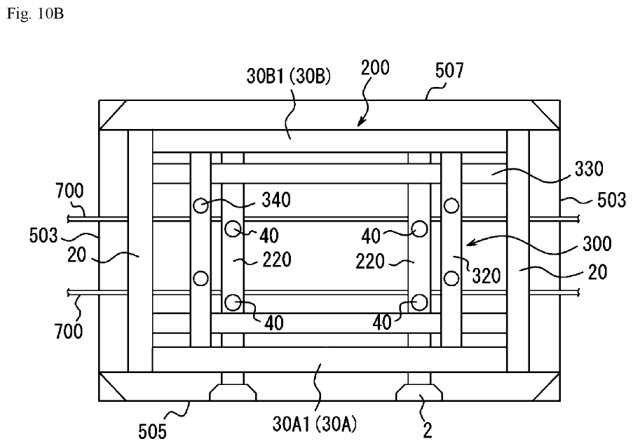

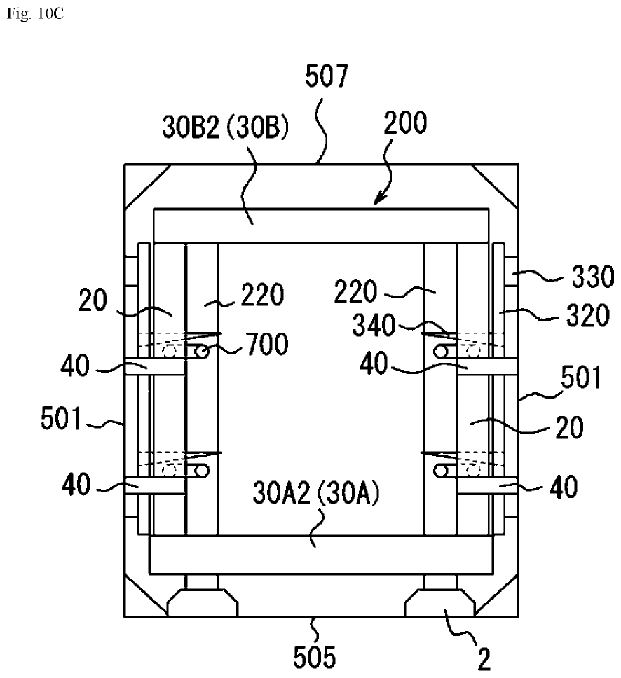

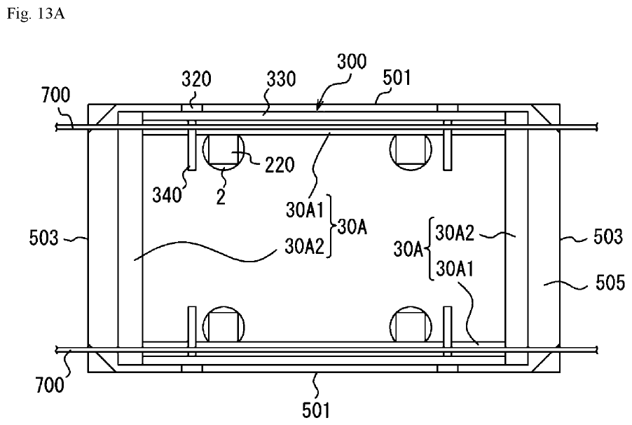

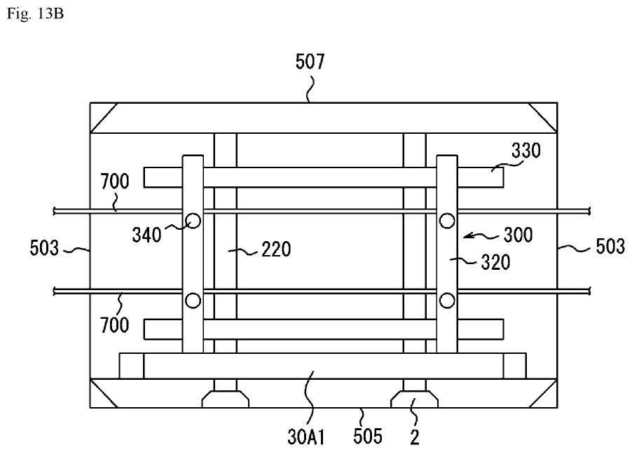

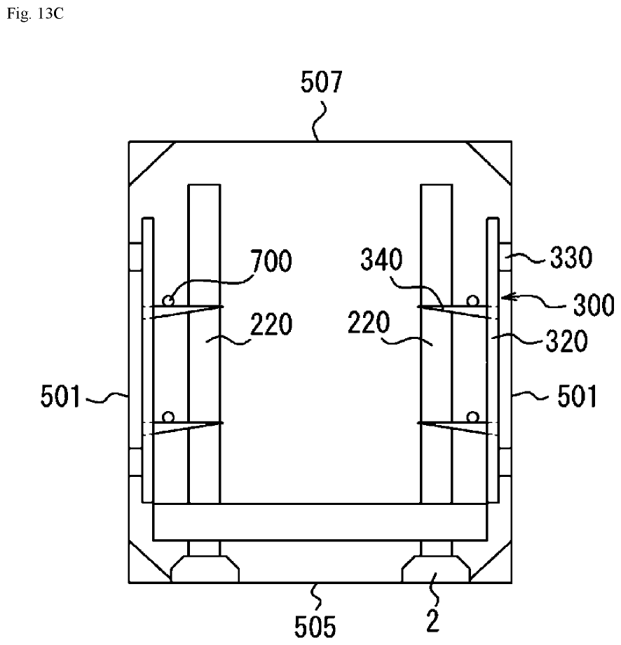

Similarly to the support device 100 according to the first embodiment, the support device 200 according to this embodiment is a device which is disposed on the bottom portion of the manhole 500 corresponding to the underground cavity and supports an underground installation such as power and communication cables. As illustrated in FIGS. 10A to 10C, the support device 200 includes four column members 220 that support the support device 200, the base 2 which is attached to the lower end portion of each column member 220, the lateral frame member 30A, the vertical frame members 20, the lateral frame member 30B, and the installation support members 40. The lateral frame member 30A is attached to the outside (the side of the longitudinal wall 501) in the direction (the left and right direction of FIG. 10C) orthogonal to the extension direction of the communication cables 700 in the column members 220 and has a rectangular shape in the plan view (see FIG. 13A). The vertical frame members 20 are attached to four corners of the lateral frame member 30A and extend in a substantially vertical direction. The lateral frame member 30B is attached to the upper end portion of each of the vertical frame members 20, connects the vertical frame members 20 to each other, and extends in the substantially horizontal direction. Each installation support member 40 is attached to the corresponding column member 220 and extends to the outside of the substantially horizontal direction orthogonal to the extension direction of the communication cables 700.

Additionally, in this embodiment, the column member 220 is used as a member extending in the substantially vertical direction in addition to the vertical frame member 20. For convenience of description of the method of manufacturing the support device 200 to be described later, the vertical frame member 20 and the column member 220 are separate members. However, because both members extend in the substantially vertical direction, their roles are similar. In the second embodiment and the claims of the specification, it should be understood that both the vertical frame member 20 and the column member 220 described above are included when the “vertical frame member” is simply used without using the reference sign.

Also in this embodiment, various fixing methods such as engagement including screw fastening, fitting, welding, and bonding can be used to fix the members to each other.

The lateral frame member 30A connects the column members 220 disposed at four positions on the bottom wall 505 of the manhole 500 in the horizontal direction and includes the longitudinal lateral frame members 30A1 each of which extends along the extension direction of the communication cables 700 (the left and right direction of FIG. 10B) and the transverse lateral frame members 30A2 each of which extends in the direction orthogonal to the extension direction of the communication cables 700 (see FIG. 13A). Further, the upper end portions of the vertical frame members 20 to be described later are provided with the lateral frame member 30B connecting the vertical frame members 20 to each other (see FIGS. 10A to 10C). As illustrated in FIG. 10A, the lateral frame member 30B also includes the longitudinal lateral frame members 30B1 each of which extends along the extension direction of the communication cable 700 and the transverse lateral frame members 30B2 each of which extends in the direction orthogonal to the extension direction of the communication cables 700.

Similarly to the first embodiment, as the materials of the lateral frame members 30A and 30B, other steel materials having predetermined strength, non-ferrous metals such as aluminum, or non-metallic materials such as fiber reinforced plastics (FRP) can be used in addition to a carbon steel material for a mechanical structure.

As illustrated in FIGS. 10B, 10C, and the like, the vertical frame members 20 are attached to four corners of the upper surface of the lateral frame member 30A and extend in the substantially vertical direction (the up and down direction of FIGS. 10B and 10C). Further, the lateral frame member 30B that connects the vertical frame members 20 to each other and extends in the substantially horizontal direction is attached to the upper end portions of the vertical frame members 20.

As illustrated in FIGS. 10B and 10C, the installation support members 40 that support the communication cable 700 are attached to two height positions between the upper end portion and the lower end portion of each column member 220. Each installation support member 40 is orthogonal to the extension direction of the communication cable 700 and extends in a substantially horizontal direction.

In this embodiment, as illustrated in FIGS. 10B, 10C, and the like, the installation support member 40 is a substantially columnar elongated member and can be fixed by being fitted to a fitting hole provided in the column member 220. The installation support member 40 may be fixed to the column member 220 by other means such as engagement, welding, and bonding, for example. Further, the installation support member 40 may be fixed to the vertical frame member 20 or the lateral frame members 30A and 30B.

In this embodiment, similarly to the first embodiment, the installation support member 40 is formed to be disposed in the vicinity of the existing brace 340 to be described later.

Similarly to the first embodiment, FIGS. 10A to 10C illustrate the existing hardware assembly 300 that supports the communication cable 700 in addition to the support device 200 according to this embodiment. The hardware assembly 300 includes the lateral flat steels 330 each of which extends in the extension direction of the communication cables 700, the vertical flat steels 320 each of which is attached to the corresponding lateral flat steel 330 and extends in the vertical direction, and the braces 340 which are provided at two height positions between the upper end portion and the lower end portion of each vertical flat steel 320 and support the communication cables 700. The column member 220 of this embodiment is disposed on the inside of the horizontal direction orthogonal to the extension direction of the communication cable 700 in relation to the communication cable 700 fixed to each brace 340.

In this embodiment, the column member 220 is disposed on the outside in relation to the inner end in the horizontal direction (the left and right direction of FIG. 10C) orthogonal to the extension direction of the communication cables 700 in the existing brace 340. With such a configuration, the area inside the brace 340 can be secured as a work space.

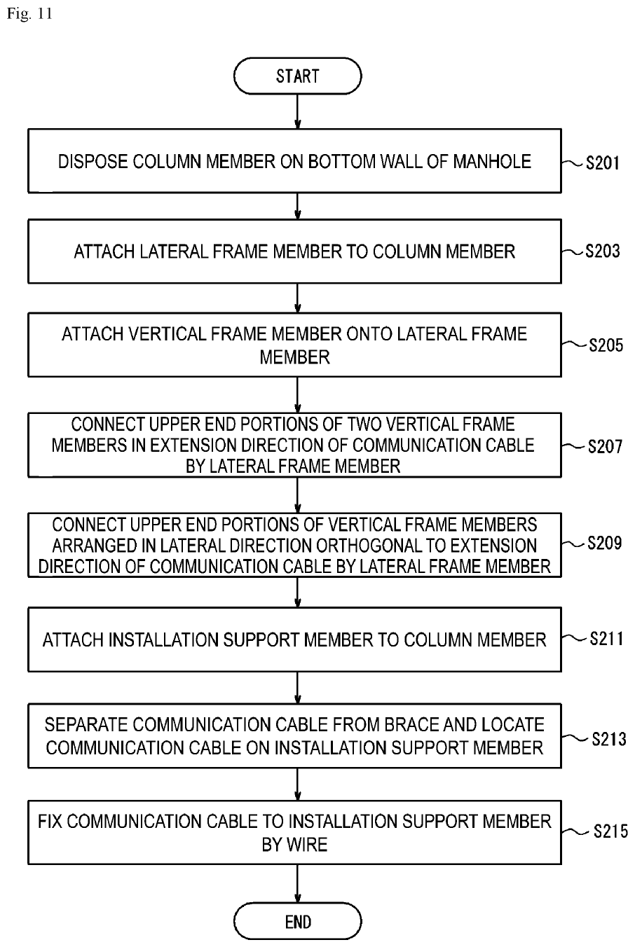

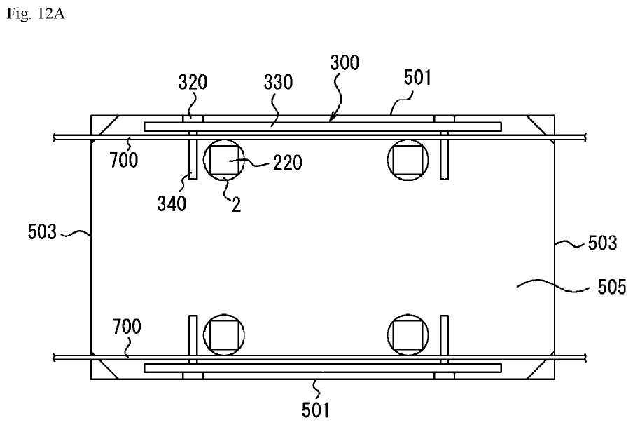

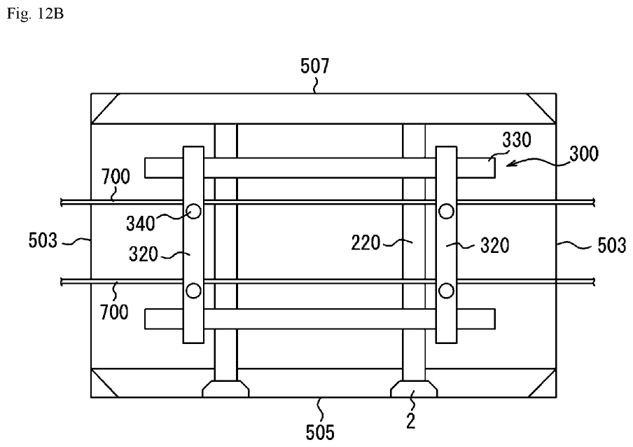

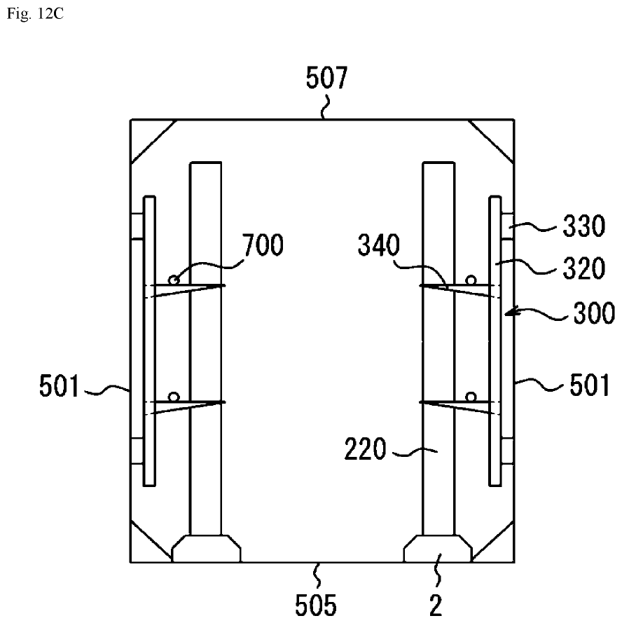

Next, a procedure of manufacturing the support device 200 according to this embodiment will be described with reference to FIG. 11 and the like. When manufacturing the support device 200, first, as illustrated in FIGS. 12A to 12C, four column members 220 each including the base 2 are disposed on the bottom wall 505 of the manhole 500 (step S201) and then, as illustrated in FIGS. 13A to 13C, the lateral frame member 30A is attached to the side surface of the column members 220 (step S203). In this embodiment, as illustrated in FIG. 12A, the column members 220 are disposed at four corner positions of the rectangular area on the bottom wall 505. In the example of FIG. 12A, the column members 220 are disposed such that the gap in the direction (the left and right direction of FIG. 12A) along the extension direction of the communication cables 700 becomes larger than the gap in the direction (the up and down direction of FIG. 12A) orthogonal to the extension direction of the communication cables 700. With such a configuration, it is possible to more stably support the communication cables 700 in the extension direction by taking advantage of the shape of the internal space of the manhole 500.

As illustrated in FIG. 13A, the longitudinal lateral frame member 30A1 of the lateral frame member 30A fixed to the column members 220 is disposed on the inside in the direction (the up and down direction of FIG. 13A) orthogonal to the extension direction of the communication cables 700 in relation to the vertical flat steel 320 and the lateral flat steel 330 and is disposed on the outside in relation to the inner end of the brace 340 in the plan view.

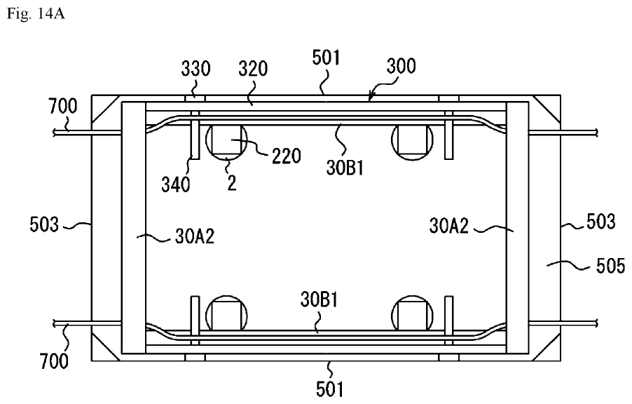

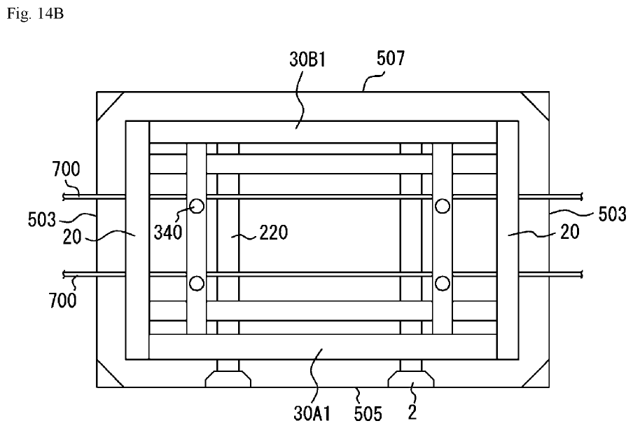

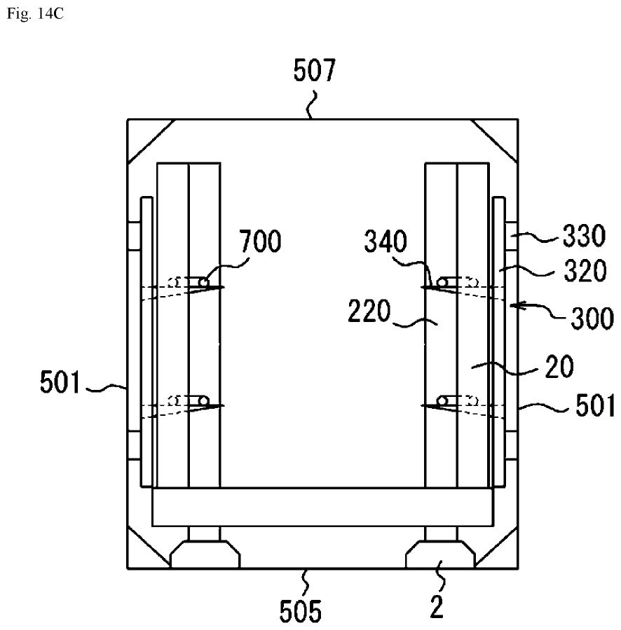

After the lateral frame member 30A is attached to the column members 220 in step S203, four vertical frame members 20 are attached to four corners of the lateral frame member 30A in the plan view as illustrated in FIGS. 14A to 14C (step S205). Further, as illustrated in FIG. 14B, the lateral frame member 30B (the longitudinal lateral frame member 30B1) connects the upper end portions of two vertical frame members 20 in the extension direction of the communication cables 700 (the left and right direction of FIG. 14B) among four vertical frame members 20 (step S207).

In step S205, as illustrated in FIG. 14C, each vertical frame member 20 is disposed on the inside in the direction (the left and right direction of FIG. 14C) orthogonal to the extension direction of the communication cable 700 in relation to the vertical flat steel 320 and the lateral flat steel 330. Further, the vertical frame member 20 is disposed on the outside in relation to the inner end of the brace 340. As a result, it is possible to secure the same work space as the work space secured inside the brace 340 in the existing hardware assembly 300 even after the support device 200 according to this embodiment is installed. Further, because the vertical frame member 20 and the longitudinal lateral frame members 30A1 and 30B1 are disposed in the vicinity of the longitudinal wall 501, the vertical frame member 20 and the longitudinal lateral frame members 30A1 and 30B1 are supported by the longitudinal wall 501 even when the manhole 500 is vibrated in the horizontal direction (the up and down direction of FIG. 14A) orthogonal to the extension direction of the communication cable 700 due to earthquake or the like. Thus, it is possible to suppress a load applied to the support device 200 caused by vibration.

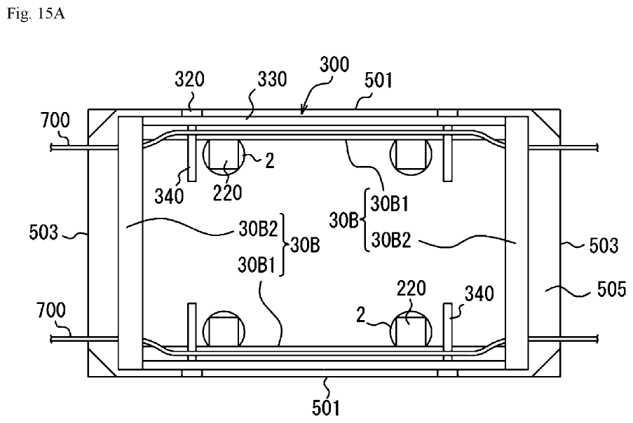

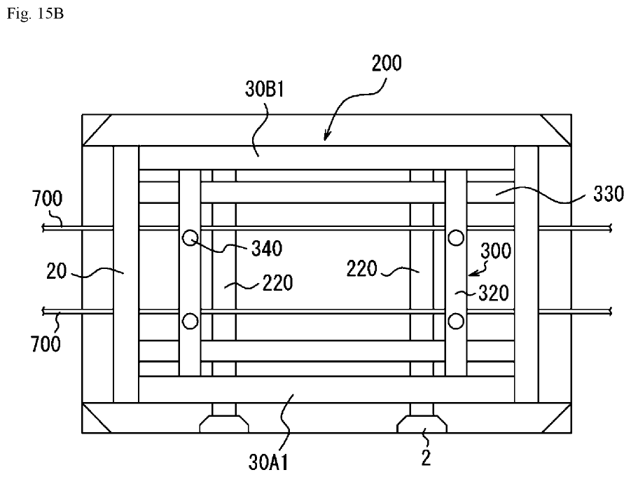

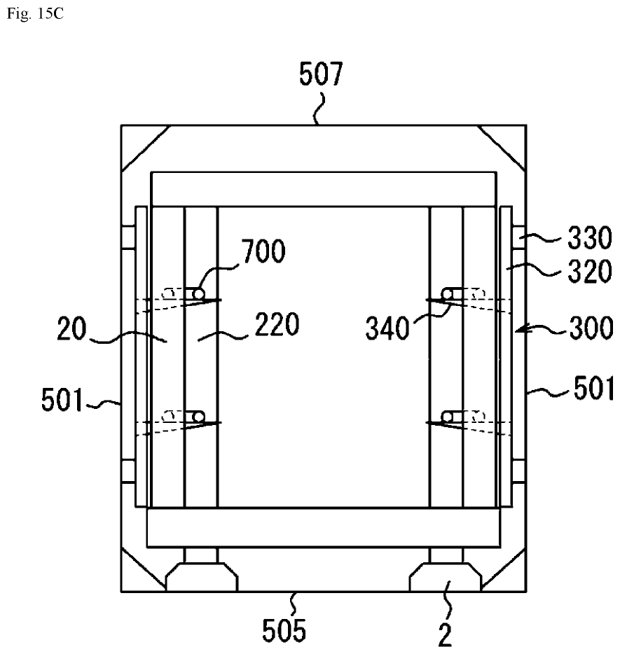

Next, the lateral frame member 30B (the transverse lateral frame member 30B2) connects the upper end portions of the vertical frame members 20 arranged in the horizontal direction (the left and right direction of FIG. 15C) orthogonal to the extension direction of the communication cables 700 (the left and right direction of FIG. 15A) (step S209). As a result, the skeleton of the support device 200 is completed.

Next, the installation support members 40 are attached to the column member 220 (step S211). In this embodiment, for the attachment of each installation support member 40, the installation support member 40 is inserted into a through-hole provided in the column member 220 and the installation support member 40 protrudes outward in the left and right direction of FIG. 15C (see FIG. 10C). As a result, because the installation place of the communication cable 700 is not limited by the work space, there is a possibility that the number of the communication cables 700 which can be supported by the installation support member 40 is increased.

Further, it is preferable that the attachment place of the installation support member 40 be in the vicinity of the brace 340 in the hardware assembly 300. As a result, it is not necessary to temporarily transfer the communication cable 700 when the communication cable 700 is relocated from the brace 340 to the installation support member 40 according to this embodiment. Further, it is possible to reduce the possibility that the communication cable 700 may be stressed when relocating the communication cable 700. The installation support member 40 may be attached to the vertical frame member 20 or the lateral frame members 30A and 30B instead of the column member 220.

After the installation support members 40 are attached in step S211, the communication cable 700 is separated from the brace 340 and is located on the corresponding installation support member 40 (step S213). Then, similarly to the case of the first embodiment (see FIGS. 2A and 2B), the wire 41 is wound along the outer circumferential surfaces of the installation support member 40 and the communication cable 700 so that the communication cable 700 is fixed to the installation support member 40 (step S215). As a result, as illustrated in FIGS. 10A to 10C, the communication cable 700 can be supported by the newly installed support device 200.

Further, as understood from FIG. 10A, in this embodiment, the vertical frame member 20 and the lateral frame members 30A and 30B are each disposed at a position farther from the longitudinal wall 501 than the vertical flat steel 320 and the lateral flat steel 330. Thus, it is possible to relatively easily remove the hardware assembly 300 from the manhole 500 by separating the vertical flat steel 320 and the lateral flat steel 330 from the longitudinal wall 501 after the brace 340 is separated from the hardware assembly 300.

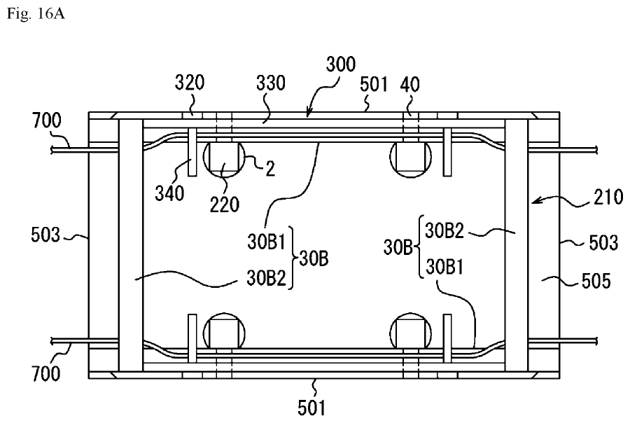

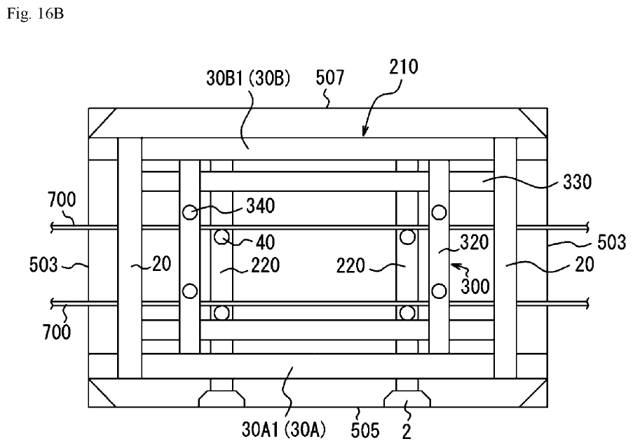

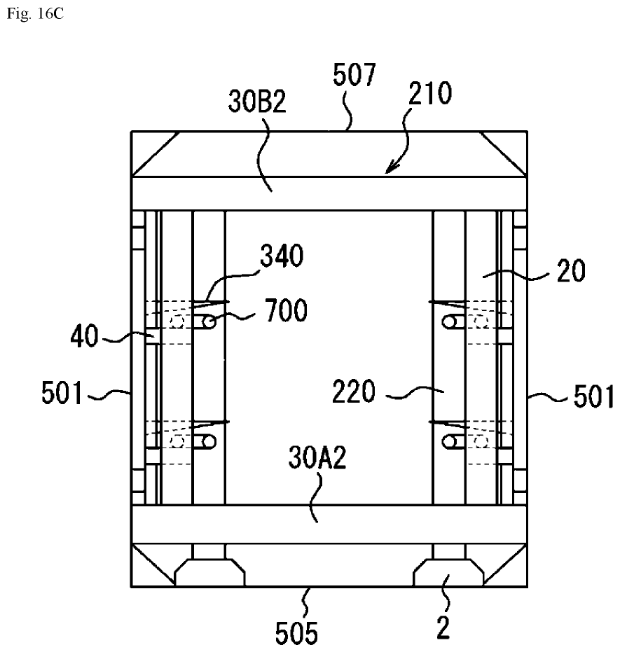

FIGS. 16A to 16C illustrate a support device 210 which is a modified example of this embodiment. In the support device 210, the lateral frame members 30A and 30B are formed to extend to a position close to the longitudinal wall 501 and the transverse wall 503 compared to the support device 200 illustrated in FIGS. 10A to 10C. With such a configuration, because the support device 210 is also supported by the longitudinal wall 501 and the transverse wall 503, even when the manhole 500 is vibrated, it is possible to protect the support device 210 from the vibration of the manhole 500.

As described above, in this embodiment, the installation support member 40 is formed to protrude outward in the horizontal direction orthogonal to the extension direction of the underground installation (the communication cable 700). By adopting such a configuration, because the installation place of the communication cable 700 is not limited by the work space, there is a possibility that the number of the communication cables 700 which can be supported by the installation support member 40 is increased. Further, because the outer end of the installation support member 40 is close to the longitudinal wall 501, the communication cable 700 does not come off from the installation support member 40 even when the existing brace 340 is removed. Thus, it is not necessary to fix the installation support member 40 and the communication cable 700 by the wire 41 or the like.

Next, a support device 250 according to a third embodiment of the disclosure will be described with reference to the drawings. The support device 250 according to this embodiment is not significantly different from that of the first modified example of the first embodiment (FIGS. 7A to 7C) except that connection pins 232 arranged on the vertical frame member 20 in the up and down direction and inserted into two fixing holes 238 extending in the extension direction of the communication cables 700 are formed to be fitted to fitting holes 239 provided in the longitudinal lateral frame members 30A1 and 30A3. Thus, a description will be given here by focusing on the difference with the first modified example of the first embodiment.

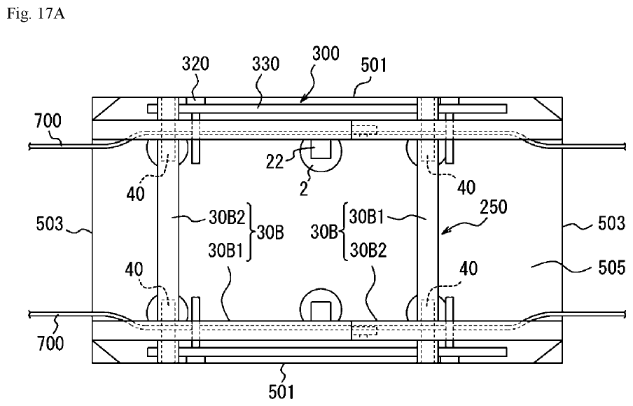

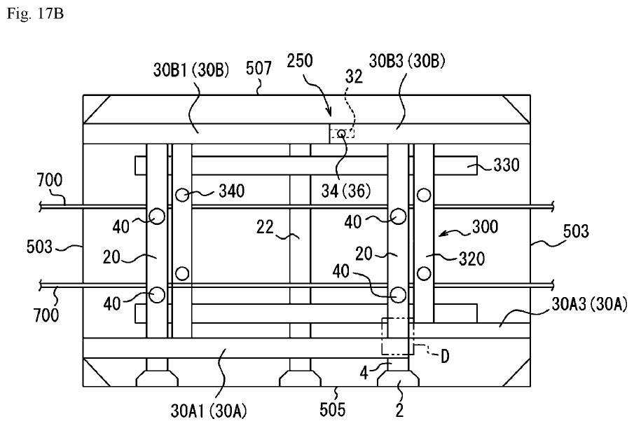

In the support device 250 according to this embodiment, as illustrated in FIGS. 17A and 17B, the lateral frame members 30A and 30B are formed to extend to a position close to the longitudinal wall 501 and the transverse wall 503. With such a configuration, because the support device 250 is also supported by the longitudinal wall 501 and the transverse wall 503 even when the manhole 500 is vibrated, it is possible to protect the support device 250 from the vibration of the manhole 500.

In this embodiment, similarly to the first modified example of the first embodiment, the longitudinal lateral frame member 30B1 is connected to the longitudinal lateral frame member 30B3 at one end portion in the longitudinal direction so that the longitudinal lateral frame member 30B1 extends to a position close to the transverse wall 503. Further, in this embodiment, one end portion of the longitudinal lateral frame member 30A1 is connected to the longitudinal lateral frame member 30A3 through the fixing holes 238 arranged on the vertical frame member 20 in the up and down direction so that the longitudinal lateral frame member 30A1 extends to a position close to the transverse wall 503.

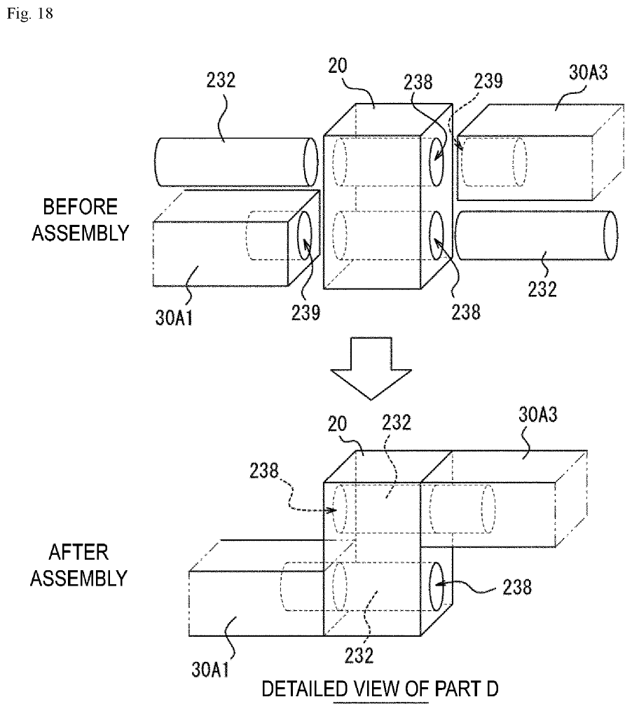

The connection of the longitudinal lateral frame members 30A1 and 30A3 will be described in more detail. As illustrated in the upper part of FIG. 18, two fixing holes 238 which are arranged in the up and down direction and extend in the extension direction of the communication cable 700 are provided in the vertical frame member 20. Each fixing hole 238 penetrates the vertical frame member 20. Then, the corresponding connection pin 232 can be fitted and fixed to each fixing hole 238 by an interference fit. Because the connection pin 232 is formed to be longer than the thickness of the vertical frame member 20 in the extension direction of the communication cable 700, one end protrudes from the vertical frame member 20 in the extension direction of the communication cable 700 even after the press-fitting to the vertical frame member 20 (see the lower part of FIG. 18).

On the other hand, one end of each of the longitudinal lateral frame members 30A1 and 30A3 is provided with the fitting hole 239 to which the connection pin 232 is fitted by a gap fit (see the upper part of FIG. 18). Thus, when the connection pin 232 is press-inserted into the fixing hole 238 after the state illustrated in the upper part of FIG. 18 and further one end of the connection pin 232 is fitted to the fitting hole 239 provided in each of the longitudinal lateral frame members 30A1 and 30A3, the longitudinal lateral frame members 30A1 and 30A3 are connected to the vertical frame member 20 to be movable in the extension direction of the communication cable 700 as illustrated in the lower part of FIG. 18. Thus, the length of the longitudinal lateral frame members 30A1 and 30A3 can be adjusted in the extension direction of the communication cable 700.

As described above, in this embodiment, the lateral frame members 30A and 30B include the longitudinal lateral frame members 30A1 and 30B1 that extend in the extension direction of the underground installation (the communication cable 700) and the transverse lateral frame members 30A2 and 30B2 that extend in the direction orthogonal to the extension direction of the underground installation. The longitudinal lateral frame member is formed such that a plurality of members 30A1 and 30A3 are connected in the extension direction of the underground installation and one member 30A1 and the other member 30A3 of the plurality of members are connected to the vertical frame member 20 to be movable in the extension direction of the underground installation. As a result, the length of the longitudinal lateral frame member can be adjusted in the extension direction of the underground installation. By adopting such a configuration, it is possible to adjust the length of the longitudinal lateral frame members so that the end portions of the longitudinal lateral frame members 30A1 and 30B1 and the longitudinal lateral frame members 30A3 and 30B3 are close to the transverse wall 503 after the support device 250 is disposed on the bottom wall 505 of the manhole 500. Thus, it is possible to adjust the size of the support device 250 in accordance with the internal space of the manhole 500. Thus, because the support device 110 is supported by the transverse wall 503 even when the manhole 500 is vibrated, it is possible to protect the support device 110 from the vibration of the manhole 500.

While the disclosure has been described with reference to the drawings and examples, it should be noted that various modifications and corrections can be made by a person skilled in the art based on the disclosure. Thus, it should be noted that these modifications and corrections are within the scope of the disclosure. For example, the functions and the like included in each of the components, steps, and the like can be rearranged so as to not be logically inconsistent and a plurality of components, steps, and the like can be combined into one or divided.

For example, in the first to third embodiments, both the communication cable 700 and the installation support member 40 are fixed by being wound by the wire 41, but the disclosure is not limited thereto. For example, the communication cable 700 may be wound by a member other than the wire 41 or may be fixed by passing through a pipe member attached as the installation support member.

Further, in the second embodiment, the installation support member 40 is formed to extend outward from the column member 220, but the disclosure is not limited thereto. The installation support member may be formed to extend inward.

### REFERENCE SIGNS LIST

2 Base
4 Base frame
10 Pedestal
20 Vertical frame member
22 Support column
24 Support column
30A Lateral frame member
30A1 Longitudinal lateral frame member
30A2 Transverse lateral frame member
30A3 Longitudinal lateral frame member
30B Lateral frame member
30B1 Longitudinal lateral frame member
30B2 Transverse lateral frame member
30B3 Longitudinal lateral frame member
32 Convex portion
40 Installation support member
41 Wire
100 Support device
110 Support device
120 Support device
130 Support device
200 Support device
210 Support device
220 Column member (vertical frame member)
232 Connection pin
238 Fixing hole
239 Fitting hole
250 Support device
300 Hardware assembly
320 Vertical flat steel
330 Lateral flat steel
340 Brace
500 Manhole (underground cavity)
501 Longitudinal wall
503 Transverse wall
505 Bottom wall (bottom portion)
507 Top wall
700 Communication cable (underground installation)

1. A support device for supporting an underground installation comprising:
a vertical frame extending in a substantially vertical direction;
a lateral frame attached to the vertical frame and extending in a substantially horizontal direction; and
an installation support attached to at least one of the vertical frame or the lateral frame,
wherein the support device is disposed on a bottom portion of an underground cavity.

2. The support device according to claim 1,
wherein the installation support protrudes outward in a horizontal direction orthogonal to an extension direction of the underground installation.

3. The support device according to claim 1,
wherein the lateral frame includes a longitudinal lateral frame that extends in an extension direction of the underground installation and a transverse lateral frame that extends in a direction orthogonal to the extension direction of the underground installation, and
the length of the longitudinal lateral frame is adjustable in the extension direction of the underground installation in such a manner that the longitudinal lateral frame is formed such that a plurality of frames and support are connected in the extension direction of the underground installation and one frame and another frame of the plurality of frames are slidably fitted to each other.

4. The support device according to claim 3, further comprising:
a support column which supports at least one of the one frame or the other frame in an up and down direction in the vicinity of a connection position between the one frame and the other frame.

5. The support device according to claim 1,
wherein the lateral frame includes a longitudinal lateral frame that extends in an extension direction of the underground installation and a transverse lateral frame that extends in a direction orthogonal to the extension direction of the underground installation, and
wherein the length of the longitudinal lateral frame is adjustable in the extension direction of the underground installation in such a manner that the longitudinal lateral frame is formed such that a plurality of frames are connected in the extension direction of the underground installation and one frame and another frame of the plurality of frames are connected to the vertical frame to be movable in the extension direction of the underground installation.

6. The support device according to claim 1,
wherein the vertical frame is installed to be inclined inward in a horizontal direction orthogonal to an extension direction of the underground installation while facing downward.

7. The support device according to claim 1,
wherein the vertical frame is disposed on the outside of an inner end in a horizontal direction orthogonal to an extension direction of the underground installation in an existing support of the underground installation.

8. A method of manufacturing a support device supporting an underground installation and disposed on a bottom portion of an underground cavity, the method comprising:
fixing a vertical frame extending in a substantially vertical direction and a lateral frame extending in a substantially horizontal direction;
disposing at least one of the vertical frame or the lateral frame on the bottom portion of the underground cavity directly or through another frame; and
attaching an installation support to at least one of the vertical frame or the lateral frame.

9. The support device according to claim 2,
wherein the lateral frame includes a longitudinal lateral frame that extends in an extension direction of the underground installation and a transverse lateral frame that extends in a direction orthogonal to the extension direction of the underground installation, and
the length of the longitudinal lateral frame is adjustable in the extension direction of the underground installation in such a manner that the longitudinal lateral frame is formed such that a plurality of frames and support are connected in the extension direction of the underground installation and one frame and another frame of the plurality of frames are slidably fitted to each other.

10. The support device according to claim 9, further comprising:
a support column which supports at least one of the one frame or the other frame in an up and down direction in the vicinity of a connection position between the one frame and the other frame.

11. The method according to claim 8,
wherein the installation support protrudes outward in a horizontal direction orthogonal to an extension direction of the underground installation.

12. The method according to claim 8,
wherein the lateral frame includes a longitudinal lateral frame that extends in an extension direction of the underground installation and a transverse lateral frame that extends in a direction orthogonal to the extension direction of the underground installation, and
the length of the longitudinal lateral frame is adjustable in the extension direction of the underground installation in such a manner that the longitudinal lateral frame is formed such that a plurality of frames and support are connected in the extension direction of the underground installation and one frame and another frame of the plurality of frames are slidably fitted to each other.

13. The method according to claim 8,
wherein the lateral frame includes a longitudinal lateral frame that extends in an extension direction of the underground installation and a transverse lateral frame that extends in a direction orthogonal to the extension direction of the underground installation, and
wherein the length of the longitudinal lateral frame is adjustable in the extension direction of the underground installation in such a manner that the longitudinal lateral frame is formed such that a plurality of frames are connected in the extension direction of the underground installation and one frame and another frame of the plurality of frames are connected to the vertical frame to be movable in the extension direction of the underground installation.

14. The method according to claim 8,
wherein the vertical frame is installed to be inclined inward in a horizontal direction orthogonal to an extension direction of the underground installation while facing downward.

15. The method according to claim 8,
wherein the vertical frame is disposed on the outside of an inner end in a horizontal direction orthogonal to an extension direction of the underground installation in an existing support of the underground installation.

16. The method according to claim 12, further comprising:
supporting at least one of the one frame or the other frame in an up and down direction in the vicinity of a connection position between the one frame and the other frame using a support column.

17. A method for supporting an underground installation, the method comprising:
extending a vertical frame in a substantially vertical direction;
attaching a lateral frame to the vertical frame and extending the lateral frame in a substantially horizontal direction;
attaching an installation support to at least one of the vertical frame or the lateral frame; and
disposing the vertical frame on a bottom portion of an underground cavity.

18. The method according to claim 17,
wherein the installation support protrudes outward in a horizontal direction orthogonal to an extension direction of the underground installation.

19. The method according to claim 17,
wherein the lateral frame includes a longitudinal lateral frame that extends in an extension direction of the underground installation and a transverse lateral frame that extends in a direction orthogonal to the extension direction of the underground installation, and
the length of the longitudinal lateral frame is adjustable in the extension direction of the underground installation in such a manner that the longitudinal lateral frame is formed such that a plurality of frames and support are connected in the extension direction of the underground installation and one frame and another frame of the plurality of frames are slidably fitted to each other.

20. The method according to claim 19,
supporting at least one of the one frame or the other frame in an up and down direction in the vicinity of a connection position between the one frame and the other frame using a support column.
